(19) United States
(12) Patent Application Publication
(10) Pub. No.: US 2026/0265076 A1
(43) Pub. Date: Sep. 10, 2026

(54) METHOD FOR THE PREPARATION OF MIXED RARE EARTH METAL CARBONATES FROM MONAZITE

(71) Applicant: TÉCNICAS REUNIDAS, S.A., Madrid (ES)

(72) Inventors: Pilar LERET MOLTÓ, San Fernando de Henares, Madrid (ES); Mª Teresa PINEDO GONZÁLEZ, San Fernando de Henares, Madrid (ES); Carlos ÁLVAREZ CARREÑO, San Fernando de Henares, Madrid (ES); Maria FRADES TAPIA, San Fernando de Henares, Madrid (ES)

(21) Appl. No.: 19/164,339

(22) PCT Filed: Mar. 13, 2024
(86) PCT No.: PCT/EP2024/056660

§ 371 Date: Sep. 11, 2025

(30) Foreign Application Priority Data
Mar. 14, 2023 (EP) 23382237.8

(51) Int. Cl. C01F 17/247; C22B 3/10; C22B 3/14; C22B 3/22; C22B 3/44; C22B 59/00

(52) U.S. Cl. CPC C01F 17/247; C22B 3/10; C22B 3/14; C22B 3/22; C22B 3/44; C22B 59/00

(57) ABSTRACT

The present invention relates to a method for the preparation of mixed rare earth metal carbonates from monazite, this method comprising a first leaching with an alkaline hydroxide and a two-step second leaching in the presence of hydrochloric acid.

### FIELD OF THE INVENTION

The present invention relates to a method for the preparation of mixed rare earth metal carbonates from monazite.

### BACKGROUND

Rare earth metals are high added value components in a broad range of applications, such as catalysts, materials for optical applications, magnets and batteries, among others. These elements are often critical materials in a wide range of technological and electronic devices used on a daily basis. While these elements are relatively abundant on earth, there are very few raw materials where rare earth elements are concentrated. Such materials include, among others, monazite and bastnasite. Due to an increasing demand of rare earth metals for such applications, efforts have been dedicated to the development of processes for the extraction of rare earth metals from mineral ores containing high concentrations of such metals, such as monazite.

Patent application U.S. Pat. No. 2,811,411 A1 discloses a method of processing monazite sand to produce trisodium phosphate by treating monazite sand with sodium hydroxide, thus producing a cake of metal hydroxides and a solution of trisodium phosphate that is further isolated by crystallization. The application also discloses briefly a treatment of the resulting cake of metal hydroxides by acidic lixiviation with HCl or HNO₃. In addition, it is further disclosed that the rare earth thorium and uranium may then be recovered from the solution by various methods, for instance, by solvent extraction. The document is however silent on the details of such methods of extraction of rare earth metals.

Patent application GB 674,400 discloses a multi-stage process for extraction of rare earth metal carbonates from monazite which comprises the following stages:
1) Preparation of monazite till reaching a particle size of 200 mesh (i.e. 75 μm);
2) Providing a 55-70% in weight (preferably 65%) NaOH aqueous solution;
3) Adding the NaOH solution gradually to the monazite particles such that the weight ratio of NaOH to monazite is 1, at a temperature of 140-145° C. during 2-5 h;
4) Diluting the slurry resulting from stage 4 at a temperature above 55° C. till reaching a concentration of NaOH of 13% by weight (130 g per liter);
5) Separation of precipitated metal hydroxides by filtration or decantation;
6) Crystallization of trisodium phosphate by cooling;
7) Filtration of trisodium phosphate
8) Recovery of trisodium phosphate with 90% yield from ore;
9) Recovery and recirculation of NaOH having a concentration of about 13% for use in dilution step 4)
10) Concentration of recirculated NaOH for use in stage 3;
11) (optional): additional decantation of metal hydroxides separated in stage 5 at a temperature above 25° C.;
12) Filtration and washing of the cake of metal hydroxides;
13) Addition of hydrochloric acid in excess till dissolving all metal hydroxides and precipitate Th and U species by addition of rare earth metal carbonates till reaching pH 4. Th and U species start to dissolve at pH values below 3.2;
14) Filtration of Th and U species to yield a liquid phase comprising rare earth metal chlorides;
15) Said rare earth metal chlorides have been recovered with over 95% of the rare earth metals rendered soluble by the attack;
16) Precipitating mixed rare earth metal carbonate by treatment with sodium carbonate.

C. K. Gupta & N. Krishnamurthy (1992) Extractive metallurgy of rare earths, International Materials Reviews, 37:1, 197-248 disclose a similar multi-stage process for extraction of rare earth metal carbonates from monazite. In particular, this process employs an acidic lixiviation step using hydrochloric acid at a pH of between 3.4 and 4. Such pH is useful for selectively dissolving rare earth chlorides while remaining radioactive waste (Th and U) in solid form. Such selective extraction is disclosed as essential to produce non-radioactive mixed rare earth metal carbonates.

Feng Xie et al. disclose in Minerals Engineering 2013, vol. 56, p. 10-28 a process for the extraction of mixed rare earth metal carbonates comprising:
1) a step of basic lixiviation of monazite particles producing a liquid fraction A which comprises sodium triphosphate and a solid fraction B which comprises hydroxide salts of rare earth metals;
2) separate solid B from liquid A;
3) a step of acidic lixiviation in hydrochloric acid of solid B, which produces a solid fraction C which comprises hydroxide salts of thorium and uranium and a liquid fraction D which comprises chloride salts of rare earth metals; and
4) separate solid C from liquid D.

Patent application CN 111 187 926 A discloses a process for the preparation of mixed rare earth chlorides from monazite, comprising:
1) a step of acidic lixiviation of monazite particles employing hydrochloric acid aiming at decreasing the amount of calcium in monazite particles and producing a solid residue that is isolated and then submitted to a step of basic lixiviation of monazite particles producing a liquid fraction A which comprises sodium triphosphate and a solid fraction B which comprises hydroxide salts of rare earth metals;
2) separate solid B from liquid A;
3) a step of acidic lixiviation in hydrochloric acid of solid B, which produces a solid fraction C which comprises hydroxide salts of thorium and uranium and a liquid fraction D which comprises chloride salts of rare earth metals; and
4) separate solid C from liquid D.

Mellodee et al. disclose in Journal of Radioanalytical and nuclear chemistry 2014, vol. 303, no 2, 1393-1398 a process for the extraction of mixed rare earth metal carbonates comprising:
1) a step of basic lixiviation of monazite particles producing a liquid fraction A which comprises sodium triphosphate and a solid fraction B which comprises hydroxide salts of rare earth metals;
2) separate solid B from liquid A;
3) a step of acidic lixiviation in hydrochloric acid of solid B, which produces a solid fraction C which comprises hydroxide salts of thorium and uranium and a liquid fraction D which comprises chloride salts of rare earth metals;
4) separate solid C from liquid D;
5) removing radium and lead from D by (i) addition of barium chloride and sodium sulfate to liquid D, thus producing radium sulfate and (ii) addition of sodium sulphide to liquid D, thus producing lead sulphide.

Patent application CN1045010C discloses a process for the extraction of rare earth metal compounds from a mixture of bastnasite and monzaite using a phosphonic acid as extractant (P507).

Patent application CN111020242 discloses a process for the preparation of mixed rare earth metal chlorides from monazite particles as well as the recovery of uranium and thorium compounds.

Patent application US2010/018347 discloses a chemical separation process for removing radium-228, from materials containing thorium-232, such as monazite.

Several processes for the extraction of rare earth metals from monazite and other ores are disclosed in G. Balachandran: “Extraction of Rare Earths for Advanced Applications” 2014, Elsevier Science, pages 1291-1340.

From what is disclosed in the art, it derives that there is still a need for providing improved methods for the extraction of mixed rare earth metal carbonates from monazite.

### SUMMARY OF THE INVENTION

After exhaustive research, the inventors have developed a process for the extraction of mixed rare earth metal carbonates from monazite characterized for having a high yield of recovery of rare earth metals, while avoiding Naturally Occurring Radioactive Materials (NORM) in the final products. The inventors have particularly found that, when the acidic lixiviation step is carried out in two steps of lixiviation employing a first lixiviation step at pH of between 1 and 2.5 and a second lixiviation stage at pH of between 3.2 and 4, the recovery of rare earth metals is improved. The specific acidic lixiviation step of the invention advantageously allows removing Th and U radioactive species in an unexpected effective manner. In addition, the amounts of other metals than rare earth metals, such as Fe, Al and Pb, in the fraction comprising the rare earth metal salts is advantageously reduced, which further facilitates downstream operation and purification of the rare earth metal carbonates.

In certain embodiments, the process of the invention presents further advantages, as it allows in certain embodiments isolating trisodium phosphate, which is a product of commercial value, in an efficient manner as said product is isolated by evaporation of a liquid fraction. The recovery of the stream of steam from said evaporation step allows recirculating water and energy at various points of the process where these are needed. In addition, the liquid fraction resulting from the precipitation of trisodium phosphate can be recycled in the process.

In certain embodiments, the process of the invention allows in particular to produce mixed rare earth metal carbonates that are substantially free of cerium species, since it allows isolating cerium (IV) hydroxide as a product of the process of commercial value. Additionally, the produced mixed rare earth metal carbonates is substantially free of radioactive components.

Thus, in a first aspect, the invention relates to a process for the preparation of mixed rare earth metal carbonate from monazite, said process comprising:
(a) submitting particles of monazite to a leaching step with an aqueous solution of alkaline hydroxide, thus obtaining a mixture of:
   a liquid fraction A comprising trisodium phosphate and
   a solid B comprising mixed hydroxide salts of the metals comprised in monazite;
(b) separating the solid B from the solution A, preferably by filtration;
(c) a leaching step of the solid B comprising:
   (c-1) a first leaching step of the solid B with a hydrochloric acid aqueous solution, feeding said hydrochloric acid solution so as the resulting mixture has a pH between 1 and 2.5;
   (c-2) a second leaching step following the first leaching step (c-1) where the pH is adjusted to a value of between 3.2 and 4 by adding an alkaline hydroxide; thus obtaining a mixture of:
      a solid fraction C comprising hydroxide salts of thorium and/or uranium, and
      a liquid fraction D comprising rare earth metal chloride salts; and
(d) separating the solid C from the liquid fraction D; preferably by filtration.

### BRIEF DESCRIPTION OF THE DRAWINGS

FIG. 1 shows a general scheme of the process of the invention.

### DETAILED DESCRIPTION

All terms as used herein in this application, unless otherwise stated, shall be understood in their ordinary meaning as known in the art. Other more specific definitions for certain terms as used in the present application are as set forth below and are intended to apply uniformly throughout the specification and claims unless an otherwise expressly set out definition provides a broader definition.

For the purposes of the invention, any ranges or particular values given include both the lower and the upper end-points of the range. Ranges given, such as temperatures, times, molar ratio, volume ratio and the like, should be considered approximate (i.e. with a 5% margin of variation around indicated point), unless specifically stated.

In the context of the invention, the term “mixed rare earth metal carbonate” refers to a mixture of carbonate salts of rare earth metals. The term “mixed rare earth metal carbonate” refers more particularly to a mixture of carbonate salts of cerium Ce, lanthanum La, neodymium Nd, praseodymium Pr, europium Eu, gadolinium Gd, dysprosium Dy, yttrium Y, scandium Sc, samarium Sm, holmium Ho, erbium Er, thulium Tm, lutetium, Lu, terbium Tb. It is preferred that the term “mixed rare earth metal carbonate” refers to a mixture of carbonate salts of cerium Ce, lanthanum La, neodymium Nd, praseodymium Pr, europium Eu, gadolinium Gd, dysprosium Dy, yttrium Y and samarium Sm. It is more preferred that the term “mixed rare earth metal carbonate” refers to a mixture of carbonate salts of lanthanum La, neodymium Nd, praseodymium Pr, europium Eu, gadolinium Gd, dysprosium Dy, yttrium Y and samarium Sm. Similarly, the term “mixed rare earth metal chloride” refers to a mixture of chloride salts of rare earth metals.

In the context of the invention, the term “monazite” refers to a phosphate mineral containing rare earth element and comprising phosphate of rare earth metals, being said rare earth metals as listed above.

In the context of the invention, the term “diameter”, when referring to the diameter of a particle refers to an average diameter of a particle whereby 80% of the population of particles have a diameter below a certain value. Such term is also commonly referred to in the art as “D80”.

As mentioned above, a first aspect of the invention relates to a process for the preparation of mixed rare earth metal carbonate from monazite, said process comprising:
(a) submitting particles of monazite to a leaching step with an aqueous solution of alkaline hydroxide, thus obtaining a mixture of:
   a liquid fraction A comprising trisodium phosphate and
   a solid B comprising mixed hydroxide salts of the metals comprised in monazite;
(b) separating the solid B from the solution A, preferably by filtration;
(c) a leaching step of the solid B comprising:
   (c-1) a first leaching step of the solid B with a hydrochloric acid aqueous solution, feeding said hydrochloric acid aqueous solution so as the resulting mixture has a pH between 1 and 2.5;
   (c-2) a second leaching step following the first leaching step (c-1) where the pH is adjusted to a value of between 3.2 and 4 by adding an alkaline hydroxide;
   thus obtaining a mixture of:
      a solid fraction C comprising hydroxide salts of thorium and uranium, and
      a liquid fraction D comprising rare earth metal chloride salts; and
(d) separating the solid C from the liquid fraction D, preferably by filtration.

Monazite comprises phosphate salts of rare earth elements. As defined above, the process of the invention comprises a first basic lixiviation step followed by a second acidic lixiviation step. The purpose of the first basic lixiviation step (a) is to break the phosphate matrix comprising the rare earth metal elements. This is achieved by treating monazite ore in concentrated alkaline medium so as to precipitate the hydroxide salts of the metals comprised in monazite. The main chemical reactions taking place during this step are:

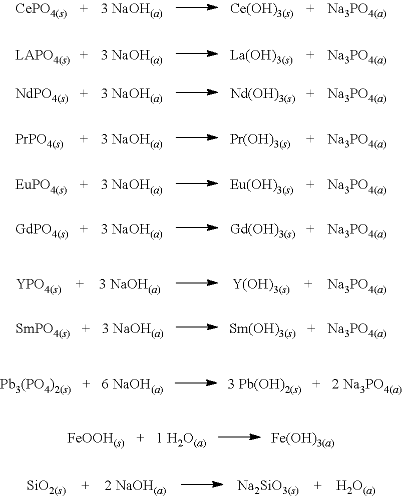

In a preferred embodiment of the process of the invention, the particles of monazite of step (a) have a particle diameter below 100 μm.

In a further preferred embodiment of the process of the invention, the alkaline hydroxide is selected from potassium hydroxide, sodium hydroxide and mixtures thereof; preferably, it is sodium hydroxide.

In a further preferred embodiment of the process of the invention, the alkaline hydroxide is sodium hydroxide and the weight ratio of sodium hydroxide to monazite is comprised between 1.5 and 2.5. When the alkaline is other than sodium hydroxide, the skilled person will adapt the weight ratio of the alkaline hydroxide accordingly.

In a further preferred embodiment of the process of the invention, the aqueous solution of alkaline hydroxide of step (a) comprises said alkaline hydroxide in an amount such that when said alkaline hydroxide is sodium hydroxide, the aqueous solution of sodium hydroxide comprises sodium hydroxide in an amount of between 50 and 60% by weight; preferably of about 55% by weight.

In a further preferred embodiment of the process of the invention, step (a) is carried out in a manner that the weight ratio of alkaline hydroxide to monazite is such that, when said alkaline hydroxide is sodium hydroxide, the weight ratio of sodium hydroxide to monazite is of between 3:2 to 3:1, preferably of about 2:1. The skilled person will know how to adapt the weight ratio of alkaline hydroxide to monazite when alkaline hydroxides other than sodium hydroxide are used.

In a further preferred embodiment of the process of the invention, step (a) is carried out at a temperature of between 130 to 160° C., preferably from 135 to 155° C., more preferably from 135 to 145° C., even more preferably of about 142° C.

In a further preferred embodiment of the process of the invention, step (a) has a duration of at least 3 hours and up to 5 hours, preferably of 4 hours.

In a further preferred embodiment of the process of the invention, step (a) further comprises diluting the obtained mixture, at about 100° C., with water so as to reach a concentration of alkaline hydroxide such that, when said alkaline hydroxide is sodium hydroxide, sodium hydroxide is in a concentration of about 25% by weight. Said dilution step is carried after the basic lixiviation step.

In a further preferred embodiment of the process of the invention, step (a) is carried out in such a manner that:
(i) the particles of monazite of step (a) have a particle diameter below 100 μm;
(ii) the alkaline hydroxide is sodium hydroxide and the aqueous solution of alkaline hydroxide of step (a) comprises sodium hydroxide in an amount of between 50 and 60% by weight; preferably of about 55% by weight;
(iii) the alkaline hydroxide is sodium hydroxide and the weight ratio of sodium hydroxide to monazite is about 2:1;
(iv) step (a) is carried out at a temperature of about 130 to 150° C., preferably at 142° C.;
(v) step (a) has a duration of at least 3 hours and up to 5 hours, preferably of 4 hours; and
(vi) step (a) further comprises diluting the obtained mixture at about 100° C. with water so as to reach a concentration of sodium hydroxide of about 25% by weight.

As mentioned above, the basic lixiviation step is followed by an acidic lixiviation comprising steps (c) and (d) as defined above. The purpose of this step is to dissolve the hydroxide metal salts comprised in the solid fraction B obtained in the first basic lixiviation step in a liquid phase by transforming them in their chloride salts. Careful choice of the pH in this step allows improving the selectivity of extraction of certain metals over others.

The following chemical reactions particularly take place during said step:

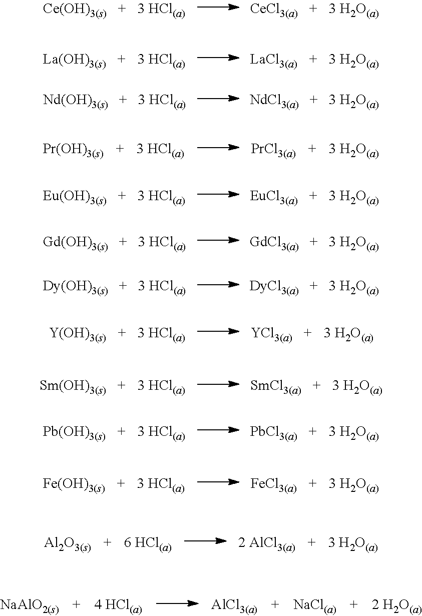

In a further preferred embodiment of the process of the invention, step (c) is one wherein step (c-1) and/or step (c-2) is carried out at a temperature between 80 and 95° C., preferably at 90° C., and/or during at least 70 minutes, preferably during 90 minutes.

In a further preferred embodiment of the process of the invention, step (c) is one wherein step (c-1) is carried out at a pH of at least 1.1, 1.2, 1.3, 1.4, 1.5, 1.6, 1.7, 1.8 or 1.9 and no more than 2.5.

In a further preferred embodiment of the process of the invention, step (c) is one wherein step (c-1) is carried out at a pH of at least 1 and less than 2.4, 2.3, 2.2 or 2.1.

In a further preferred embodiment of the process of the invention, step (c) is one wherein step (c-1) is carried out at a pH of about 2.

In a further preferred embodiment of the process of the invention, step (c) is one wherein the pH of the mixture resulting from step (c-2) is adjusted to a value of between 3.2 and 4, preferably of 3.6, by addition of potassium hydroxide.

In a further preferred embodiment of the process of the invention, step (c) is one wherein step (c-2) is carried out at a pH of at least 3.3, 3.4 or 3.5 and no more than 4.

In a further preferred embodiment of the process of the invention, step (c) is one wherein the pH of the mixture resulting from step (c-2) is adjusted to a value of at least 3.2 and less than 4, 3.9, 3.8 or 3.7.

In a further preferred embodiment of the process of the invention, step (c) is one wherein step (c-2) is carried out at a pH of about 3.6.

In a further preferred embodiment of the process of the invention, step (c) is one wherein solid B is fed as a suspension at a concentration of between 200 and 500 g per liter, preferably of about 300 g per liter.

In a further preferred embodiment of the process of the invention, step (c) is one wherein:
(i) step (c-1) is carried out at a temperature between 80 and 95° C., preferably at 90° C. and/or during at least 70 minutes, more preferably during 90 minutes;
(ii) step (c-1) is carried out at a pH of about 2;
(iii) step (c-2) is carried out at a pH of about 3.6;
(iv) step (c-2) is carried out at a temperature between 8° and 95° C., preferably at 90° C. and/or during at least 70 minutes, preferably during 90 minutes;
(v) the pH of the mixture of step (c-1) is adjusted to 3.6 by addition of an alkaline hydroxide such as potassium hydroxide; and
(vi) solid B is fed as a suspension at a concentration of between 200 and 500 g per liter, preferably of about 300 g per liter.

Thus, in a more preferred embodiment of the process of the invention, step (a) is one wherein:
(i) the particles of monazite of step (a) have a particle diameter below 100 μm;
(ii) the alkaline hydroxide is sodium hydroxide and the aqueous solution of alkaline hydroxide of step (a) comprises sodium hydroxide in an amount of between 50 and 60% by weight; preferably of about 55% by weight;
(iii) the alkaline hydroxide is sodium hydroxide and the weight ratio of sodium hydroxide to monazite is about 2:1;
(iv) step (a) is carried out at a temperature of about 130 to 150° C., preferably at 142° C.;
(v) step (a) has a duration of at least 3 hours and up to 5 hours, preferably of 4 hours; and
(vi) step (a) further comprises diluting the obtained mixture at 100° C. with water so as to reach a concentration of sodium hydroxide of about 25% by weight; and step (c) is one wherein:
(i) step (c-1) is carried out at a temperature between 80 and 95° C., preferably at 90° C. and/or during at least 70 minutes, preferably during 90 minutes;
(ii) step (c-1) is carried out at a pH of about 2;
(iii) step (c-2) is carried out at a pH of about 3.6;
(iv) step (c-2) is carried out at a temperature between 80 and 95° C., preferably at 90° C. and/or during at least 70 minutes, preferably during 90 minutes;
(v) the pH of the mixture of step (c-1) is adjusted to 3.6 by addition of an alkaline hydroxide such as potassium hydroxide; and
(vi) solid B is fed as a suspension at a concentration of between 200 and 500 g per liter, preferably of about 300 g per liter.

The process disclosed above advantageously allows to reduce the amount of non-rare earth metals, such as Th, U, Pb, Fe and Al, extracted together with the rare earth metals in the liquid fraction D resulting from the acidic lixiviation step. This allows for an easier preparation of mixed rare earth metal carbonates with improved purity profile, for liquid fraction D resulting from the acidic lixiviation step comprises a minor amount of non-desired components such as Th, U, Pb, Fe and Al than the processes known in the art wherein the acidic lixiviation is carried out at constant pH.

The process of the invention may comprise further steps aiming at further reducing the amount of impurities in the fractions comprising the rare earth metals and converting said fraction in mixed rare earth metal carbonates.

In particular, it is contemplated that the process of the invention comprises the step of removing substantially all the Ra(II) and/or Pb(II) species comprised in the liquid fraction D, preferably by precipitation of RaSO₄ and/or PbS. This step advantageously allows reducing the radioactivity of the mixed rare earth metal fraction.

Thus, in a preferred embodiment, the process of the invention further comprises the steps of:
(e) contacting the liquid fraction D with a barium(II) source, a sulfate source and a sulfide source so as to precipitate substantially all the Ra(II) and Pb(II) species comprised in said liquid fraction in the form of RaSO₄ and PbS; thus obtaining:
   a solid fraction E comprising lead sulfide and sulfate salts of barium and radium, and
   a liquid fraction F comprising mixed rare earth metal chloride salts;
(f) separating the liquid fraction F from the solid fraction E, preferably by filtration.

In said preferred embodiment, step (e) preferably comprises the steps of:
(e-1) precipitating sulfate salts of radium by contacting the liquid fraction D with a barium(II) source and a sulfate source;
(e-2) precipitating lead sulfide by contacting the product obtained in step (e-1) with a sulfide(II) source.

In a preferred embodiment, in step (e-1), the barium source is barium chloride. It is also preferred that the sulfate source is potassium sulfate.

In said preferred embodiments, step (e-1) is one wherein the following chemical reaction takes place:

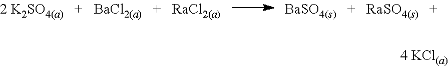

In a preferred embodiment, in step (e-2), the sulfide (II) source is sodium sulfide. In said preferred embodiment, step (e-2) is one wherein the following chemical reaction takes place:

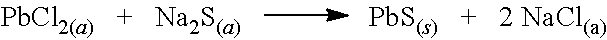

In said preferred embodiment, said step (e-1) preferably satisfies one or more, preferably all, of the following conditions:
(i) the sulfate source is potassium sulfate;
(ii) the amount of sulfate source is such that the concentration of sulfate in the medium of step (f) is of between 5 and 15 g per liter, preferably of 10 g per liter;
(iii) the barium(II) source is barium(II) chloride;
(iv) the amount of barium(II) source is such that the molar ratio of Ba(II) to sulfate is of between 1:5 and 1:15, preferably of 1:10;
(v) the temperature is of between 50° C. and 90° C.; preferably between 60° C. and 80° C.; more preferably of about 70° C.; and/or
(vi) the reaction time is of at least 45 minutes, preferably of about 60 minutes;

In said preferred embodiment, said step (e-2) preferably satisfies one or more, preferably all, of the following conditions:
(i) the pH of the reaction medium of step (e-2) is 3.6 and is optionally adjusted by addition of an alkaline hydroxide such as potassium hydroxide;
(ii) the sulfide(II) source is sodium sulfide,
(iii) the amount of sulfide(II) source is such that the molar ratio of lead to sulfide is about 1:1; and/or
(iv) the temperature is of between 50° C. and 90° C.; preferably between 60° C. and 80° C.; more preferably of about 70° C.

The combination of steps (e) and (f) produces a liquid fraction F comprising rare earth metal chlorides that is substantially free of Ra(II) and Pb(II) species. These species typically involve radioactive isotopes of Ra(II) and Pb(II). Thus, the combination of steps (e) and (f) allows producing a liquid fraction that is substantially free of radioactive isotopes of radium and lead in any of their known cationic forms. In particular, the liquid fraction F advantageously meets the regulatory requirements of Spanish RD783/2001 and RD 1439/2010.

It is further contemplated that the process of the invention comprises the step of removing substantially all the Ce(III) cations in the liquid fraction comprising the rare earth metal chloride salts, preferably by oxidative precipitation of cerium(IV) hydroxide. This step is advantageous as it allows isolating a valuable rare earth metal, i.e. cerium, from the mixture of rare earth metals. As will be obvious to the skilled person, said step may be carried out on any liquid fraction comprising cerium(III) chloride obtained in the process of the invention. For instance, it may be carried out on liquid fraction D, resulting from the acidic lixiviation step, or on liquid fraction F, resulting from the step of removal of Ra(II) and Pb(II) species. It is however preferred that this step is carried out on liquid fraction F.

Thus, in a preferred embodiment, the process of the invention further comprises the steps of:
(g) converting substantially all the Ce(III) cations of the liquid fraction F in Ce(IV) hydroxide by submitting said liquid fraction F to oxidative conditions; thus obtaining:
   a solid fraction G consisting essentially of cerium(IV) hydroxide; and
   a liquid fraction H comprising rare earth metal chloride salts; and
(h) separating the liquid fraction H from the solid fraction G.
   As mentioned above, said step may be carried out on liquid fraction D resulting from step (d).

In said preferred embodiment, step (g) preferably comprises contacting liquid fraction F with a hypochlorite salt such as sodium hypochlorite; more preferably, step (g) satisfies one or more of the following conditions:
(i) the temperature is of between 50° C. and 90° C.; preferably between 60° C. and 80° C.; more preferably of about 70° C.;
(ii) the pH of the reaction medium is of between 3 and 4, preferably of about 3.5; and/or
(iii) sodium hypochlorite is present in an amount of at least 2 moles per each mole of cerium(III) chloride in liquid fraction F, preferably of 3 moles per every 2 moles of cerium(III) chloride in liquid fraction F.

The process of the invention is suitable for producing mixed rare earth metal carbonates. It is thus contemplated that the process of the invention comprises the step of converting a liquid fraction comprising chloride salts of rare earth metals, such as liquid fractions D, F and H of the process disclosed herein, in a solid mixed rare earth metal carbonates; preferably by precipitation of the carbonate salts of rare earth metals.

The choice of the liquid fraction chosen as raw material for this step is dependent on the purity profile of the target mixed rare earth metal carbonates. It is thus preferred that said step of precipitation of the carbonate salts of rare earth metals is carried out on liquid fraction F or H, for these fractions are substantially free of radioactive species of Ra(II) and Pb(II). As the skilled person will appreciate, the desirability of the presence of large amounts of cerium in the mixed rare earth metal carbonates will determine the choice of the fraction F over the fraction H as a raw material, and vice versa. It is however preferred that this step is carried out on liquid fraction H.

Thus, the process of the invention may further comprise the steps of:
(i) contacting the liquid fraction H with an alkaline carbonate salt such as sodium carbonate so as to precipitate substantially all the rare earth metals comprised in said fraction in the form of carbonate salts; thus obtaining
   a solid fraction I consisting of mixed rare earth metal carbonate salts, and
   a liquid fraction J comprising rare earth metal chloride salts and
(j) separating the solid fraction I from the liquid fraction J; preferably by filtration.
   Said process may be carried out on either of fractions D or F.

Step (i) of the process of the invention is preferably carried out at a temperature of between 50° C. and 100° C.; preferably of about 70° C.

Step (i) of the process of the invention is preferably carried out at a pH of between 5.5 and 6.5, preferably of about 6.

The alkaline carbonate salt employed in step (i) is preferably sodium carbonate. Said alkaline carbonate is preferably used as an aqueous solution wherein the concentration of the alkaline carbonate is such that, when said alkaline carbonate is sodium carbonate, the aqueous solution has a concentration of alkaline carbonate of between 150 and 200 grams per liter. The skilled person will know which concentration to employ when carbonate salts other than sodium carbonate are employed.

In said preferred embodiment, step (i) preferably satisfies one or more, preferably all, of the following conditions:
(i) the temperature is of 70° C.;
(ii) sodium carbonate is added as an aqueous solution having a concentration of about 180 grams per liter; and/or
(ii) the amount of alkaline carbonate is such that the pH of the solution is 6.

Thus, in a more preferred embodiment of the process of the invention, step (a) is one wherein:
(i) the particles of monazite of step (a) have a particle diameter below 100 μm;
(ii) the alkaline hydroxide is sodium hydroxide and the aqueous solution of sodium hydroxide of step (a) comprises sodium hydroxide in an amount of between 50 and 60% by weight; preferably of about 55% by weight;
(iii) the alkaline hydroxide is sodium hydroxide and the weight ratio of sodium hydroxide to monazite is about 2:1;
(iv) step (a) is carried out at a temperature of about 130 to 150° C., preferably at 142° C.;
(v) step (a) has a duration of at least 3 hours and up to 5 hours, preferably of 4 hours; and
(vi) step (a) further comprises diluting the obtained mixture at 100° C. with water so as to reach a concentration of sodium hydroxide of about 25% by weight;
   step (c) is one wherein:
(i) step (c-1) is carried out at a temperature between 80 and 95° C., preferably at 90° C. and/or during at least 70 minutes, preferably during 90 minutes;
(ii) step (c-1) is carried out at a pH of about 2;
(iii) step (c-2) is carried out at a pH of about 3.6;
(iv) step (c-2) is carried out at a temperature between 80 and 95° C., preferably at 90° C. and/or during at least 70 minutes, preferably during 90 minutes;
(v) the pH of the mixture of step (c-1) is adjusted to 3.6 by addition of an alkaline hydroxide such as potassium hydroxide; and
(vi) solid B is fed as a suspension at a concentration of between 200 and 500 g per liter, preferably of about 300 g per liter;
   and the process further comprises the steps of:
   (e-1) precipitating sulfate salts of radium by contacting the liquid fraction D with a barium(II) source and a sulfate source, wherein said step (e-1) satisfies the following conditions:
      (i) the sulfate source is potassium sulfate;
      (ii) the amount of sulfate source is such that the concentration of sulfate in the medium of step (f) is of between 5 and 15 g per liter, preferably of 10 g per liter;
      (iii) the barium(II) source is barium(II) chloride;
      (iv) the amount of barium(II) source is such that the molar ratio of Ba(II) to sulfate is of between 1:5 and 1:15, preferably of 1:10;
      the temperature is of between 50° C. and 90° C.; preferably between 60° C. and 80° C.; more preferably of about 70° C.; and
      (vi) the reaction time is of at least 45 minutes, preferably of about 60 minutes;
   (e-2) precipitating lead sulfide by contacting the product obtained in step (e-1) with a sulfide(II) source wherein said step (e-2) satisfies the following conditions:
      (i) the pH of the reaction medium of step (e-2) is 3.6 and is optionally adjusted by addition of an alkaline hydroxide such as potassium hydroxide;
      (ii) the sulfide(II) source is sodium sulfide,
      (iii) the amount of sulfide(II) source is such that the molar ratio of lead to sulfide is about 1:1; and
      (iv) the temperature is of between 50° C. and 90° C.; preferably between 60° C. and 80° C.; more preferably of about 70° C.;
   (f) separating the liquid fraction F from the solid fraction E by filtration;
   (g) converting substantially all the Ce(III) cations of the liquid fraction F in Ce(IV) hydroxide by submitting said liquid fraction F to oxidative conditions; thus obtaining:
      a solid fraction G consisting essentially of cerium(IV) hydroxide; and
      a liquid fraction H comprising rare earth metal chloride salts; wherein said step (g) satisfies the following conditions:
         (i) the temperature is of 70° C.;
         (ii) the pH of the reaction medium is of between 3 and 4, preferably of about 3.5; and
         (iii) sodium hypochlorite is present in an amount of at least 2 moles per each mole of cerium(III) chloride in liquid fraction F, preferably of 3 moles per every 2 moles of cerium(III) chloride in liquid fraction F;
   (h) separating the liquid fraction H from the solid fraction G;
   (i) contacting the liquid fraction H with an alkaline carbonate salt such as sodium carbonate so as to precipitate substantially all the rare earth metals comprised in said fraction in the form of carbonate salts; thus obtaining
      a solid fraction I consisting of mixed rare earth metal carbonate salts, and
         a liquid fraction J comprising rare earth metal chloride salts; wherein step (i) satisfies the following conditions:
         (i) the temperature is of 70° C.;
         (ii) the alkaline carbonate is sodium carbonate and is added as an aqueous solution having a concentration of about 180 grams per liter; and/or
         (ii) the amount of alkaline carbonate is such that the pH of the solution is 6; and
   (j) separating the solid fraction I from the liquid fraction J by filtration.

The basic lixiviation steps (a)-(b) produce a liquid fraction that is rich in trisodium phosphate, which is a valuable product. It is further contemplated that the process of the invention comprises steps for the recovery of this compound.

Thus, in a preferred embodiment, the process of the invention further comprises the step of:
(k) precipitating trisodium phosphate from liquid fraction A and
(l) isolating said trisodium phosphate by solid-liquid separation, thus obtaining trisodium phosphate and a liquid fraction K; preferably by filtration.

Methods for precipitating trisodium phosphate are known in the art and include, for instance, cooling liquid fraction A. It is however preferred that trisodium phosphate is precipitated by water evaporation.

Said water evaporation step preferably satisfies one or more, preferably all, of the following conditions:
(i) the water evaporation step comprises heating the liquid fraction A at a temperature of 128° C. for 90 minutes,
(ii) the evaporated water is further condensed and optionally recirculated at the dilution step of step (b) when step (b) comprises diluting the mixture at 100° C. with water so as to reach a concentration of alkaline hydroxide of about 25% by weight,
(iii) trisodium phosphate is precipitated at a temperature of between 20° C. and 40° C.; preferably of 30° C. during a period of time of between 60 and 120 minutes, preferably of 90 minutes; and/or
(iv) trisodium phosphate is isolated by filtration.

It is further contemplated that the liquid fraction K, that is rich in sodium hydroxide, is recirculated in step (a) of the process of the invention. Liquid fraction K however comprises as well silicate species that are prompt to accumulate in the process upon recirculation of said fraction in step (a).

A preferred embodiment of the process of the invention thus comprises the step of removing silicate species from said liquid fraction K.

It is further preferred that the removal of silicate species is carried out by precipitation of calcium silicate, according to the following reaction:

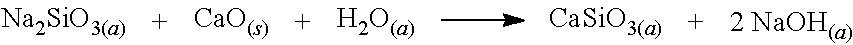

Thus, the process of the invention further comprises the steps of:
(m) contacting the liquid fraction K with calcium oxide in a sufficient amount to precipitate substantially all the silicate salts comprised in said liquid fraction in the form of calcium silicate; thus obtaining:
a solid fraction L comprising calcium silicate, and
a liquid fraction M enriched in sodium hydroxide, and
   (n) isolating said liquid fraction M by solid-liquid separation.
   The resulting liquid fraction M advantageously presents a reduced amount of silicate species and is suitable for being fed to step (a) of the process, as a source of sodium hydroxide, with a reduced risk of accumulation of silicate species in the process.

The process of the invention may thus comprise the step of feeding liquid fraction M to step (a).

Thus, in a more preferred embodiment of the process of the invention, step (a) is one wherein:
(i) the particles of monazite of step (a) have a particle diameter below 100 μm;
(ii) the alkaline hydroxide is sodium hydroxide and the aqueous solution of sodium hydroxide of step (a) comprises sodium hydroxide in an amount of between 50 and 60% by weight; preferably of about 55% by weight;
(iii) the alkaline hydroxide is sodium hydroxide and the weight ratio of sodium hydroxide to monazite is about 2:1;
(iv) step (a) is carried out at a temperature of about 130 to 150° C., preferably at 142° C.;
(v) step (a) has a duration of at least 3 hours and up to 5 hours, preferably of 4 hours; and
(vi) step (a) further comprises diluting the obtained mixture at 100° C. with water so as to reach a concentration of sodium hydroxide of about 25% by weight;
   step (c) is one wherein:
(i) step (c-1) is carried out at a temperature between 80 and 95° C., preferably at 90° C. and/or during at least 70 minutes, preferably during 90 minutes;
(ii) step (c-1) is carried out at a pH of about 2;
(iii) step (c-2) is carried out at a pH of about 3.6;
(iv) step (c-2) is carried out at a temperature between 80 and 95° C., preferably at 90° C. and/or during at least 70 minutes, preferably during 90 minutes;
(v) the pH of the mixture of step (c-1) is adjusted to 3.6 by addition of an alkaline hydroxide such as potassium hydroxide; and
(vi) solid B is fed as a suspension at a concentration of between 200 and 500 g per liter, preferably of about 300 g per liter;
   and the process further comprises the steps of:
   (e-1) precipitating sulfate salts of radium by contacting the liquid fraction D with a barium(II) source and a sulfate source, wherein said step (e-1) satisfies the following conditions:
      (i) the sulfate source is potassium sulfate;
      (ii) the amount of sulfate source is such that the concentration of sulfate in the medium of step (f) is of between 5 and 15 g per liter, preferably of 10 g per liter;
      (iii) the barium(II) source is barium(II) chloride;
      (iv) the amount of barium(II) source is such that the molar ratio of Ba(II) to sulfate is of between 1:5 and 1:15, preferably of 1:10;
      the temperature is of between 50° C. and 90° C.; preferably between 60° C. and 80° C.; more preferably of about 70° C.; and
      (vi) the reaction time is of at least 45 minutes, preferably of about 60 minutes;
   (e-2) precipitating lead sulfide by contacting the product obtained in step (e-1) with a sulfide(II) source wherein said step (e-2) satisfies the following conditions:
      (i) the pH of the reaction medium of step (e-2) is 3.6 and is optionally adjusted by addition of an alkaline hydroxide such as potassium hydroxide;
      (ii) the sulfide(II) source is sodium sulfide,
      (iii) the amount of sulfide(II) source is such that the molar ratio of lead to sulfide is about 1:1; and
      (iv) the temperature is of 70° C.;
   (f) separating the liquid fraction F from the solid fraction E by filtration;
   (g) converting substantially all the Ce(III) cations of the liquid fraction F in Ce(IV) hydroxide by submitting said liquid fraction F to oxidative conditions; thus obtaining:
      a solid fraction G consisting essentially of cerium(IV) hydroxide; and
      a liquid fraction H comprising rare earth metal chloride salts; wherein said step (g) satisfies the following conditions:
         (i) the temperature is of 70° C.;
         (ii) the pH of the reaction medium is of between 3 and 4, preferably of about 3.5; and
         (iii) sodium hypochlorite is present in an amount of at least 2 moles per each mole of cerium(III) chloride in liquid fraction F, preferably of 3 moles per every 2 moles of cerium(III) chloride in liquid fraction F;
   (h) separating the liquid fraction H from the solid fraction G;
   (i) contacting the liquid fraction H with an alkaline carbonate salt such as sodium carbonate so as to precipitate substantially all the rare earth metals comprised in said fraction in the form of carbonate salts; thus obtaining
      a solid fraction I consisting of mixed rare earth metal carbonate salts, and
      a liquid fraction J comprising rare earth metal chloride salts; wherein step (i) satisfies the following conditions:
         (i) the temperature is of 70° C.;
         (ii) sodium carbonate is added as an aqueous solution having a concentration of about 180 grams per liter; and/or
         (ii) the amount of alkaline carbonate is such that the pH of the solution is 6;
   (j) separating the solid fraction I from the liquid fraction J by filtration;
   (k) precipitating trisodium phosphate from liquid fraction A by water evaporation wherein step (k) satisfies the following conditions:
      (i) the water evaporation step comprises heating the liquid fraction A at a temperature of 128° C. for 90 minutes,
      (ii) the evaporated water is further condensed and optionally recirculated at the dilution step of step (b) when step (b) comprises diluting the mixture at 100° C. with water so as to reach a concentration of sodium hydroxide of about 25% by weight,
      (iii) trisodium phosphate is precipitated at a temperature of between 20° C. and 40° C.; preferably of 30° C. during a period of time of between 60 and 120 minutes, preferably of 90 minutes
   (l) isolating said trisodium phosphate by solid-liquid separation, thus obtaining trisodium phosphate and a liquid fraction K by filtration;
   (m) contacting the liquid fraction K with calcium oxide in a sufficient amount to precipitate substantially all the silicate salts comprised in said liquid fraction in the form of calcium silicate; thus obtaining:
   a solid fraction L comprising calcium silicate, and
   a liquid fraction M enriched in sodium hydroxide,
   (n) isolating said liquid fraction M by solid-liquid separation, and
   (o) optionally, feeding liquid fraction M to step (a).

As mentioned above, the process of the invention advantageously allows obtaining mixed rare earth metal carbonate with high yields of extraction while minimizing the amount of impurities such as Th, U, Pb, Fe and Al.

In a more preferred embodiment, the process of the invention satisfies one or more of the following conditions:
(i) the process allows recovering at least 71% of the cerium present in monazite in the form of cerium(IV) hydroxide;
(ii) the process allows recovering at least 73% of the lanthanum present in monazite in the form of mixed rare earth metal carbonate;
(iii) the process allows recovering at least 59% of the neodymium present in monazite in the form of mixed rare earth metal carbonate;
(iv) the process allows recovering at least 59% of the praseodymium present in monazite in the form of mixed rare earth metal carbonate;
(v) the process allows recovering at least 44% of the europium present in monazite in the form of mixed rare earth metal carbonate;
(vi) the process allows recovering at least 50% of the gadolinium present in monazite in the form of mixed rare earth metal carbonate;
(vii) the process allows recovering at least 37% of the dysprosium present in monazite in the form of mixed rare earth metal carbonate;
(viii) the process allows recovering at least 57% of the yttrium present in monazite in the form of mixed rare earth metal carbonate; and/or
(ix) the process allows recovering at least 53% of the samarium present in monazite in the form of mixed rare earth metal carbonate.

In a more preferred embodiment, the process of the invention satisfies one or more of the following conditions:
(i) the process produces mixed rare earth metal carbonates wherein the content of Fe is lower than 0.01% dried weight;
(ii) the process produces mixed rare earth metal carbonates wherein the content of Th is lower than 0.01% dried weight;
(iii) the process produces mixed rare earth metal carbonates wherein the content of U is lower than 0.01% dried weight; and/or
(iv) the process produces mixed rare earth metal carbonates wherein the content of Al is lower than 0.6% dried weight.

Throughout the description and claims the word “comprises” and variations of the word, are not intended to exclude other technical features, additives, components or steps. Furthermore, the word “comprise” encompasses the cases of “consist of” and “consists essentially of”. Additional objects, advantages and features of the invention will become apparent to those skilled in the art upon examination of the description or may be learned by practice of the invention. The following examples are provided by way of illustration, and they are not intended to be limiting of the present invention.

### EXAMPLES

### Employed Raw Material

The raw material employed in the process of the invention is a mineral concentrate of monazite ore, obtained by concentrating the monazite fraction of a mineral mined extract.

Different monazite concentrates with the following average composition shown in Table 1, expressed in dried weight %, have been used in the steps of the process described below:

TABLE 1

| | Average composition (wt %) |
|---|---|
| [PO₄] | 10-25 |
| [Ce] | 5-15 |
| [La] | 2-10 |
| [Pr] | 0.5-3 |
| [Nd] | 3-10 |
| [Sm] | 0.5-3 |
| [Eu] | 0.1-1 |
| [Gd] | 0.1-3 |
| [Dy] | 0.05-1 |
| [Y] | 0.1-1 |
| [U] | 0.005-0.02 |
| [Th] | 0.01-0.2 |
| [Fe] | 5-20 |
| [Al] | 1-10 |
| [Si] | 5-20 |
| [Pb] | 0.005-0.5 |

The real density and apparent density of said raw materials was determined as being respectively 3.26 g/cm³ and 1.07 g/cm³. The varying amounts of each component of monazite in the monazite sample account for the variations in compositions observed in the liquids and solids effluents obtained in each step of the process detailed below.

In the following procedure, the composition of liquid fractions for each of the process steps was determined as follows:
the content of NaOH was determined by acid-base titration following well-established procedures known to the skilled person;
the content of phosphate, iron, aluminium, silicon and lead was determined by ICP-OES following well-established procedures known to the skilled person;
the content of rare earth metals was determined by ICP-MS following well-established procedures known to the skilled person.

In the following procedure, the composition of solid fractions for each of the process steps was determined as follows:
content of iron and lead: a weighed sample of the solid was digested with aqua regia and the content of iron and lead of the liquid phase was determined by ICP-OES following well-established procedures known to the skilled person;
content of phosphate, aluminium and silicon: a weighed sample of the solid was digested with a solution of sodium peroxide and the content of phosphate of the liquid phase was determined by ICP-OES following well-established procedures known to the skilled person;
content of rare earth metals: a weighed sample of the solid was digested with a solution of sodium peroxide and the content of rare earth metals was determined by ICP-MS following well-established procedures known to the skilled person.

ICP-OES measurements were carried out using a Perkin Elmer Optima 8300 instrument. ICP-MS measurements were carried out using a NexION 300X instrument.

General Procedure for the Preparation of Mixed Rare Earth Metal Carbonate from Monazite

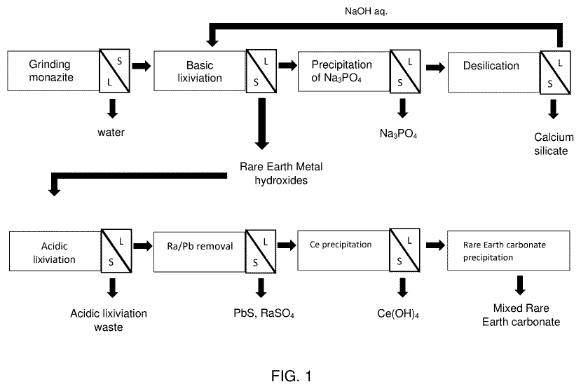

The process of extraction of mixed rare earth metal carbonate from monazite of the invention is summarized in FIG. 1. The process of the invention comprises the process steps defined in the first aspect of the invention.

### Basic Leaching Step (Step (a))

This step was carried out by contacting the employed monazite concentrate sample having the composition shown in Table 2a (540 g) with an aqueous sodium hydroxide solution of 55% by weight (prepared from 1080 g of NaOH and 884 mL H₂O), wherein the weight ratio of sodium hydroxide to monazite was 2:1, at a temperature of 142° C. during a period of 4 hours. After said treatment, the mixture was diluted with water at 100° C. so as to reach a concentration of sodium hydroxide of 25% by weight. The precipitated metal hydroxide salts were separated by filtration (solid B1). The filtration operation also produces a liquid fraction A1.

TABLE 2a

| | Monazite composition (wt %) |
|---|---|
| [PO₄] | 11.81 |
| [Ce] | 7.52 |
| [La] | 3.52 |
| [Pr] | 1.07 |
| [Nd] | 4.27 |
| [Sm] | 0.62 |
| [Eu] | 0.11 |
| [Gd] | 0.36 |
| [Dy] | 0.07 |
| [Y] | 0.16 |
| [U] | <0.01 |
| [Th] | 0.07 |
| [Fe] | 12.38 |
| [Al] | 4.95 |
| [Si] | 18.57 |
| [Pb] | 0.05 |

Experimental procedure was as follows:
Step (a): 884 grams of water were loaded in the reactor. 1080 grams of NaOH were slowly added in the reactor so as to obtain [NaOH] 55 wt % concentration. The solution was maintained under vigorous agitation. When NaOH solution reached 90° C., 540 grams (dry weight) of monazite concentrate were slowly added to the reactor. Reaction media was gradually heated up to 115-120-125-130-140° C. Once temperature reached 141-142° C., the reaction media was kept under these conditions for 4 hours. After 4 hours, reaction media was let to cool down to 100° C. and then 1910 mL of water were added to the reactor. This diluted mixture was agitated for 1 hour.
Step (b): The reaction pulp was filtered and the resulting cake was washed with 1 L of water. After filtration two streams were obtained:
   [i] liquid fraction A1 (Phosphate Liquor Solution), which consists of a mixture of the first filtrate and the washing liquor.
   [ii] solid B1 comprising the washed cake of hydroxide salts of rare earth metals.

Table 2b shows the composition of the isolated fractions:

TABLE 2b

| | Liquid fraction A1 (g/L) | Solid B1 (wt %) |
|---|---|---|
| [PO₄] | 16.1 | 0.720 |
| [Ce] | 0.002 | 9.000 |
| [La] | <0.001 | 3.360 |
| [Pr] | <0.001 | 1.150 |
| [Nd] | 0.001 | 4.390 |
| [Sm] | <0.001 | 0.843 |
| [Eu] | <0.001 | 0.116 |
| [Gd] | <0.001 | 0.365 |
| [Dy] | <0.001 | 0.071 |
| [Y] | 0.004 | 0.199 |
| [U] | 0.005 | <0.010 |
| [Th] | <0.001 | 0.062 |
| [Fe] | 0.213 | 14.100 |
| [Al] | 0.282 | 5.690 |
| [Si] | 13.4 | 11.500 |
| [Pb] | 0.051 | <0.100 |
| [NaOH] | 12.4 wt % | — |

The yield (expressed as a percentage) of leaching of phosphate species in the liquid fraction, calculated as (i) the ratio of the weight amount of phosphate in the liquid fraction resulting from the lixiviation step to the weight amount of phosphate in the monazite concentrate or as (ii) the ratio of the difference between the weight amount of phosphate in the monazite concentrate and the weight amount of phosphate in solid B1, to the weight amount of phosphate in the monazite concentrate, is of 95%. In contrast, the yield of leaching of rare earth metals in the liquid fraction, calculated as (i) the ratio of the weight amount of rare earth metals in the liquid fraction resulting from the lixiviation step to the weight amount of rare earth metals in the monazite concentrate, or as (ii) the ratio of the difference between the weight amount of rare earth meals in the monazite concentrate and the weight amount of rare earth metals in solid B1, to the weight amount of rare earth metals in the monazite concentrate, is negligible. As will be appreciated by the skilled person, both approaches for the determination of the yield provide identical results. That is, substantially all the rare earth metal cations present in the monazite particles are comprised in the solid fraction B1 after this step.

Trisodium Phosphate Isolation (Steps (k)-(l))
Ste k): The liquid fraction A1 resulting from step (a) defined above was evaporated at 128° C. during 1.5 h. The produced steam is re-compressed and recycled, to minimize the steam consumption in this operation. The condensed steam can be returned as a supply for boiler water make-up, and/or employed as a hot water supply, which is used for washing the solids at one or more of the steps of caustic leaching, silicon removal and cerium precipitation. In this way, overall water and energy consumption in the whole process is optimized. The resulting mixture was then cooled down at 30° C. by means of a cooling coil to allow the precipitation of trisodium phosphate.
Ste (l): The precipitated trisodium phosphate was isolated by filtration, thus producing a liquid fraction K1 and a solid fraction consisting essentially of trisodium phosphate.

Table 3 shows the composition of the isolated fractions:

TABLE 3

| | | Trisodium phosphate |
|---|---|---|
| | Liquid fraction K1 (g/L) | (wt %) |
| [PO₄] | 16.1 | 46.50 |
| [Na] | 0.002 | 32.60 |
| [U] | 0.005 | <0.01 |
| [Th] | <0.001 | <0.001 |
| [Fe] | 0.213 | — |
| [Al] | 0.282 | 0.095 |
| [Si] | 13.4 | 0.772 |
| [Pb] | 0.051 | <0.100 |
| [NaOH] | 38.80 wt % | — |

The yield (expressed as a percentage) of isolation of trisodium phosphate for this step is 79%. Said yield is calculated as (i) the ratio of the weight amount of phosphate in the isolated trisodium phosphate to the weight amount of phosphate in liquid fraction A1, or as (ii) the ratio of the difference between the weight amount of phosphate in liquid fraction A1 and the weight amount of said phosphate in the liquid fraction K1, to the weight amount of said phosphate in liquid fraction A1. As will be appreciated by the skilled person, both approaches for the determination of the yield provide identical results
Desilication Step (Steps (m)-(n))

The liquid fraction K1 resulting from step (I) described above was submitted to a desilication step by addition of calcium oxide so as to promote the precipitation of calcium silicate according to the following reaction:

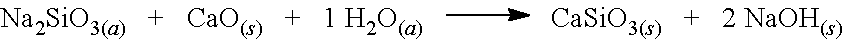

### Experimental Procedure was as Follows:

Step (m): A total of 1460 mL of liquid fraction K1 were loaded in a crystal beaker. Temperature was raised up to 120° C. under vigorous agitation. A total of 77 grams (dry weight) of calcium oxide were added to the reaction mixture and left for 1.5 hour.
Step (n): Filtration of the resulting pulp produced two streams: a liquid fraction M1 that is enriched in NaOH and a solid fraction L1 consisting of calcium silicate. This step advantageously allows recirculating said fraction M1 to step (a) of the process, which is rich in sodium hydroxide (45% by weight) with no accumulation of silicate species in the process.

Table 4 shows the composition of the isolated fractions:

TABLE 4

| | Liquid fraction M1 (g/L) | Solid fraction L1 (wt %) |
|---|---|---|
| [PO₄] | 0.778 | 3.61 |
| [Na] | — | 21.6 |
| [U] | 0.001 | <0.01 |
| [Th] | <0.001 | <0.01 |
| [Fe] | 0.316 | 0.718 |
| [Al] | 0.486 | 0.168 |
| [Si] | 4.11 | 11.70 |
| [Pb] | 0.106 | <0.10 |
| [NaOH] | 42.90% | — |

The measured yield (expressed as a percentage) of precipitation of silicate was of 89% calculated as (i) the ratio of the weight amount of silicate in the solid fraction L1 resulting from steps (m) and (n) to the weight amount of silicate in liquid fraction K1, or as (ii) the ratio of the difference between the weight amount of silicate in liquid fraction K1 and the weight amount of said silicate in the liquid fraction M1 resulting from steps (m) and (n), to the weight amount of said silicate in liquid fraction K1). As will be appreciated by the skilled person, both approaches for the determination of the yield provide identical results. Liquid fraction M1 is suitable for being fed in step (a).
Acidic Lixiviation Step (Steps (c)-(d))

In the following experiments, a solid B2 obtainable from steps (a) and (b) performed as described above on a monazite sample having the composition described in Table 5 was used, said solid having the composition described in Table 5:

TABLE 5

| | Starting monazite | |
|---|---|---|
| | (wt %) | Solid B2 (wt %) |
| [PO₄] | 15.6 | 0.95 |
| [Ce] | 7.73 | 8.87 |
| [La] | 3.37 | 3.56 |
| [Pr] | 1.11 | 1.17 |
| [Nd] | n.d. | 4.60 |
| [Sm] | 0.867 | 0.75 |
| [Eu] | 0.161 | 0.15 |
| [Gd] | 0.514 | 0.45 |
| [Dy] | 0.099 | 0.09 |
| [Y] | 0.214 | 0.18 |
| [U] | 0.01 | 0.01 |
| [Th] | 0.083 | 0.07 |
| [Fe] | 15.63 | 14.3 |
| [Al] | 3.85 | 5.38 |
| [Si] | 11.03 | 10.1 |
| [Pb] | 0.0083 | 0.05 |

Ste (c: Solid B2 obtained in step (a) was submitted to an acidic lixiviation step taking place in two stages. Solid B2 (180 g) was suspended in water at a concentration of 300 g/L. The reaction pulp was heated up to 90° C. with vigorous agitation. The pH of the resulting solution was adjusted at pH 2 or 3.6 as indicated in Table 6 with hydrochloric acid at 37% (w/v). The resulting mixture was left at 90° C. for 90 minutes or 180 minutes as indicated in Table 6. In entry 3 of Table 6, pH of the solution was then adjusted from 2 to 3.6 by addition of a KOH aqueous solution (300 g/L) and the resulting mixture was further left at 90° C. during 90 minutes.
Ste d): The resulting suspension was then filtered, thus producing a solid residue C2 comprising Th and U and a liquid fraction D2 comprising rare earth metal chloride salts.

Table 6 shows the leaching efficiency obtained for certain elements for an acidic lixiviation step of solid B2 carried out at different pH values and for different periods of time. Leaching efficiencies are expressed as a percentage and calculated as (i) the ratio of the weight amount of an element in the liquid fraction resulting from step (c) to the weight amount of the same element in solid B2 obtained in step (a) or as (ii) the ratio of the difference between the weight amount of a rare earth metal in solid B2 and the weight amount of said rare earth metal in the solid fraction resulting from step (c), to the weight amount of the same element in solid B2. As will be appreciated by the skilled person, both approaches for the determination of the yield provide identical results. Entries 1 and 2 are provided as comparative examples, while entry 3 represents an example of a process according to the invention.

TABLE 6

| | | | 3 |
|---|---|---|---|
| Entry | 1 | 2 | 2 then 3.6 |
| pH | 3.6 | 2 | 1.5 at pH = 2 + |
| Residence | 3 | 3 | 1.5 at pH = 3.6 |
| time (h) | Leaching Efficiency (%) | | |
| Ce | 79 | 99 | 84 |
| La | 86 | 99 | 93 |
| Pr | 79 | 99 | 90 |
| Nd | 83 | 99 | 89 |
| Sm | 73 | 92 | 84 |
| Eu | 74 | 92 | 82 |
| Gd | 76 | 92 | 84 |
| Dy | 69 | 91 | 75 |
| Y | 72 | 90 | 80 |
| U | 30 | 45 | 29 |
| Th | 20 | 15 | — |
| Fe | 7 | 5 | 0 |
| Al | 11 | 45 | 5 |
| Si | 4 | 10 | 5 |
| Pb | 32 | 83 | 52 |

The results of Table 6 show that, when the acidic leaching step is carried out at a pH of 2 (entry 2), the efficiency of the leaching of rare earth metals is very high at the expense of the co-extraction of other elements, such as Fe, Al, Si, Pb, U and Th in large amounts. The results of entry 3 show a balance between high rare earth recovery yields and low solubilization of Al, Si, U or Th in the liquid fraction, said elements being known to be detrimental elements for the downstream process. In particular, U and Th are of particular relevance, for they are radioactive elements and thus need to be treated separately. Si containing wastes renders the filtration operations more difficult and the presence of Al is known to negatively affect downstream extraction processes.

Table 7 shows the composition of the isolated fractions resulting from step (d):

TABLE 7

| | Liquid fraction | Solid fraction |
|---|---|---|
| | D2 (g/L) | C2 (%) |
| Ce | 15.9 | 1.95 |
| La | 6.9 | 0.349 |
| Pr | 2.34 | 0.164 |
| Nd | 8.45 | 0.676 |
| Sm | 1.9 | 0.196 |
| Eu | 0.316 | 0.038 |
| Gd | 0.968 | 0.105 |
| Dy | 0.158 | 0.032 |
| Y | 0.295 | 0.051 |
| U | <0.001 | <0.01 |
| Th | <0.001 | 0.122 |
| Fe | <0.005 | 20.5 |
| Al | 0.034 | 8.58 |
| Si | 0.068 | 13.7 |
| Pb | 0.066 | 0.023 |

Radionuclide Deactivation (Steps (e)-(f))

A liquid fraction D3 obtained from the process comprising steps (a)-(d) described above and having the composition shown in Table 8 was used in the present steps (e)-(f). Said composition also comprises trace amounts of Ra and Pb radioisotopes (not shown in the composition Tables disclosed herein).

TABLE 8

| | Liquid D3 (g/L) |
|---|---|
| [Ce] | 15.24 |
| [La] | 6.62 |
| [Pr] | 1.85 |
| [Nd] | 7.16 |
| [Sm] | 1.35 |
| [Eu] | 0.22 |
| [Gd] | 0.605 |
| [Dy] | 0.101 |
| [Y] | 0.239 |
| [U] | <0.001 |
| [Th] | <0.001 |
| [Fe] | 0.071 |
| [Al] | 0.199 |
| [Si] | 0.055 |
| [Pb] | 0.081 |

Liquid D resulting from step (d) comprises radioactive traces of Ra and Pb which must be removed to provide a mixed rare earth metal carbonate that is not radioactive. This is achieved by consecutive selective precipitation of radium sulfate and lead sulfide.

Step (e) was performed in a continuous mode with continuous inlet flow of liquid D3 in the following conditions and using the following reagents:
Liquid D inlet flow: 2 L/h
Temperature: 70° C.
Sulfate addition agent: K₂SO₄ from a 90 g/L stock solution, in order to maintain a sulfate concentration in the media of 10 g/L. Residence time: 30 minutes.
Barium addition agent: BaCl₂ from a 75 g/L stock solution was added in an amount such that the molar ratio of barium to sulfate is 1:10 in the media. Residence time: 30 minutes.
pH adjustment agent: KOH from a 300 g/L stock solution, in order to adjust the pH of the media to 3.6. Residence time: 30 minutes.
Sulfide addition agent: Na₂S from a 1.2 g/L stock solution was added in an amount such that the molar ratio of lead chloride to sodium sulfide is 1:1. Residence time: 60 minutes.
Total residence time: 150 minutes.
SteD (f): The reaction pulp was continuously filtered (step (g)) and two principal streams were generated.
   A liquid fraction F3 comprising rare earth chloride solution, substantially free of radioactive elements.
   a solid fraction E3 comprising barium sulfate, radium sulfate and lead sulfide.

Table 9 shows the composition of fractions E3 and F3 as well as the yield (expressed in %) of co-extraction of rare earth metal salts in the solid fraction E3, said yield (expressed as a percentage) being calculated as (i) the ratio of the weight amount of a rare earth metal in fraction E3 to the weight amount of the same rare earth metal in liquid fraction D3 or as (ii) the ratio of the difference between the weight amount of a rare earth metal in liquid fraction D3 and the weight amount of said rare earth metal in the liquid fraction F3, to the weight amount of said rare earth metal in liquid fraction D3. As will be appreciated by the skilled person, both approaches for the determination of the yield provide identical results:

TABLE 9

| | | | Yield of co- |
|---|---|---|---|
| | Liquid fraction F3 | Solid fraction | extraction in E3 |
| | (g/L) | E3 (%) | (%) |
| Ce | 11.3 | 14.3 | 7 |
| La | 5 | 5.7 | 6 |
| Pr | 1.37 | 1.68 | 7 |
| Nd | 5.4 | 5.7 | 6 |
| Sm | 1.09 | 0.64 | 4 |
| Eu | 0.18 | 0.13 | 5 |
| Gd | 0.53 | 0.3 | 4 |
| Dy | 0.09 | 0.017 | 1 |
| Y | 0.22 | 0.01 | 0 |
| U | <0.001 | 0.01 | — |
| Th | <0.001 | 0.01 | — |
| Fe | 0.019 | 0.51 | — |
| Al | 0.152 | 0.34 | — |
| Si | 0.042 | 0.35 | — |
| Pb | 0.065 | 0.1 | — |

Radioisotope analysis of liquid and solid fractions E3 and F3 reveals that the liquid fraction is substantially free of radioactive elements and satisfies the requirements of applicable regulations related to Spanish RD783/2001 and RD 1439/201.
Isolation of Cerium Hydroxide (Steps (q)-(h))

A liquid fraction F4 obtained from a process comprising steps (a)-(f) described above and having the composition shown in Table 10 was used in the present steps (g)-(h):

TABLE 10

| | Liquid F4 (g/L) |
|---|---|
| [Ce] | 11.8 |
| [La] | 5.86 |
| [Pr] | 1.98 |
| [Nd] | 6.96 |
| [Sm] | 1.41 |
| [Eu] | 0.229 |
| [Gd] | 0.77 |
| [Dy] | 0.136 |
| [Y] | 0.243 |
| [U] | <0.001 |
| [Th] | <0.001 |
| [Fe] | 0.003 |
| [Al] | <0.005 |
| [Si] | 0.068 |
| [Pb] | 0.063 |

The liquid fraction F4 resulting from step (f) was treated with sodium hypochlorite (76.6 g/L stock solution) and potassium hydroxide so as to promote the precipitation of cerium(IV) hydroxide according to the chemical reaction:

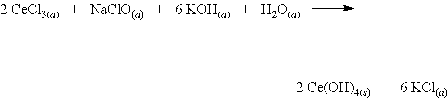

NaClO was added in an amount so as to keep 3 times the stochiometric dose according to the previously described reaction. The pH of the liquid fraction F4 was adjusted to 3.5 by addition of potassium hydroxide (100 g/L stock solution) and further KOH was added in an amount of 0.7 times the stochiometric dose according to previously described reaction.

### Experimental Procedure was as Follows:

### Step (a):

900 mL of liquid F4 were loaded in a 2 L glass reactor.
The solution was stirred and heated to 70° C.
pH of the solution was adjusted at 3.5 with minor addition of KOH.
108 mL of oxidant reagent (solution of NaClO at 76.6 g/L) was progressively added over one hour to the solution.
90 mL of precipitating agent (solution of KOH at 100 g/L) was progressively added to the solution.
Step (h): After 3 hours, the reaction pulp was filtered and two principal streams were generated:
(i) a liquid fraction H4 comprising chloride salts of rare earth metals, and
(ii) a solid fraction G4 comprising cerium hydroxide.

Table 11 shows the composition of the isolated fractions resulting from step (h):

TABLE 11

| | Liquid fraction H4 (g/L) | Solid fraction G4 (wt %) |
|---|---|---|
| [Ce] | 0.001 | 63.4 |
| [La] | 4.61 | 0.33 |
| [Pr] | 1.48 | 0.57 |
| [Nd] | 5.37 | 2.10 |
| [Sm] | 0.995 | 0.7 |
| [Eu] | 0.169 | 0.133 |
| [Gd] | 0.552 | 0.340 |
| [Dy] | 0.102 | 0.132 |
| [Y] | 0.205 | 0.087 |
| [U] | <0.001 | <0.010 |
| [Th] | <0.001 | <0.010 |
| [Fe] | 0.002 | — |
| [Al] | 0.098 | <0.010 |
| [Si] | 0.049 | 0.569 |
| [Pb] | 0.032 | 0.12 |

Table 12 shows the efficiency of this precipitation step, expressed as a percentage and calculated as (i) the ratio of the weight amount of a metal in solid fraction G4 to the weight amount of said metal in liquid fraction F4 or as (ii) the ratio of the difference between the weight amount of a metal in liquid fraction F4 and the weight amount of said metal in the liquid fraction H4, to the weight amount of said metal in liquid fraction F4. As will be appreciated by the skilled person, both approaches for the determination of the yield provide identical results

TABLE 12
Metal precipitation yield

| | |
|---|---|
| Ce (%) | 99 |
| La (%) | 6 |
| Pr (%) | 10 |
| Nd (%) | 10 |
| Sm (%) | 15 |
| Eu (%) | 11 |
| Gd (%) | 14 |
| Dy (%) | 9 |
| Y (%) | 0 |

Precipitation of Mixed Rare Earth Metal Carbonate (Steps (i)-(j))

A liquid fraction H5 obtained using the process comprising steps (a)-(h) described above and having the composition shown in Table 13 was used in the present example:

TABLE 13

| | Liquid H5 (g/L) |
|---|---|
| [Ce] | 0.01 |
| [La] | 5.4 |
| [Pr] | 1.43 |
| [Nd] | 5.73 |
| [Sm] | 0.96 |
| [Eu] | 0.16 |
| [Gd] | 0.59 |
| [Dy] | 0.09 |
| [Y] | 0.215 |
| [U] | <0.001 |
| [Th] | <0.001 |
| [Fe] | <0.002 |
| [Al] | 0.034 |
| [Si] | 0.023 |
| [Pb] | 0.050 |

### Step (i):

The pH of the liquid fraction H5 was adjusted to pH 6 by addition of an aqueous solution of sodium carbonate at a concentration of 180 g/L and the resulting mixture was left at 70° C. for one hour. This step allowed the precipitation of mixed rare earth metal carbonate.
Step (j): Precipitated mixed rare earth metal carbonate was isolated from the mixture by filtration.

Table 14 shows the composition of the isolated solid and liquid fractions rare earth metal carbonate resulting from step (j):

TABLE 14

| | Liquid fraction (g/L) | Solid fraction (%) |
|---|---|---|
| [Ce] | <0.001 | 0.037 |
| [La] | 0.003 | 20.9 |
| [Pr] | <0.001 | 5.66 |
| [Nd] | 0.001 | 23.8 |
| [Sm] | <0.001 | 3.73 |
| [Eu] | <0.001 | 0.641 |
| [Gd] | <0.001 | 2.33 |
| [Dy] | <0.001 | 0.367 |
| [Y] | <0.001 | 0.982 |
| [U] | <0.001 | <0.01 |
| [Th] | <0.001 | <0.01 |
| [Fe] | 0.010 | <0.010 |
| [Al] | <0.005 | 0.586 |
| [Si] | 0.006 | 0.419 |
| [Pb] | <0.050 | 0.149 |

The yield (expressed as a percentage) of the precipitation step, calculated as (i) the ratio of the weight amount of a rare earth metal in the solid fraction resulting from step (j) to the weight amount of said rare earth element in liquid fraction H5, or as (ii) the ratio of the difference between the weight amount of a rare earth metal in liquid fraction H5 and the weight amount of said rare earth metal in the liquid fraction resulting from step (j) to the weight amount of said rare earth element in liquid fraction H5, was of 99% for each of La, Pr, Nd, Sm Eu, Gd, Dy and Y, while a yield of 88% for the carbonate precipitation step was observed for Ce. As will be appreciated by the skilled person, both approaches for the determination of the yield provide identical results.

1. A process for the preparation of mixed rare earth metal carbonate from monazite, said process comprising:
(a) submitting particles of monazite to a leaching step with an aqueous solution of alkaline hydroxide, thus obtaining a mixture of:
a liquid fraction A comprising trisodium phosphate and
a solid B comprising mixed hydroxide salts of the metals comprised in monazite;
(b) separating the solid B from the solution A, preferably by filtration;
(c) a leaching step of the solid B comprising:
(c-1) a first leaching step of the solid B with a hydrochloric acid aqueous solution, feeding said hydrochloric acid aqueous solution so as the resulting mixture has a pH between 1 and 2.5;
(c-2) a second leaching step following the first leaching step (c-1) where the pH is adjusted to a value of between 3.2 and 4 by adding an alkaline hydroxide;
thus obtaining a mixture of:
a solid fraction C comprising hydroxide salts of thorium and uranium, and
a liquid fraction D comprising rare earth metal chloride salts; and
(d) separating the solid C from the liquid fraction D, preferably by filtration.

2. Process according to claim 1 wherein step a) satisfies one or more of:
(i) the particles of monazite have a particle diameter below 100 μm;
(ii) a temperature of about 130 to 150° C.:
(iii) the alkaline hydroxide is sodium hydroxide and the resulting aqueous solution of sodium hydroxide comprises sodium hydroxide in an amount of between 50 and 60% by weight; and/or
(iv) the alkaline hydroxide is sodium hydroxide and the weight ratio of sodium hydroxide to monazite is about 2:1.

3.-6. (canceled)

7. Process according to claim 1, wherein step (a) further comprises diluting the obtained mixture at 100° C. with water so as to reach a concentration of sodium hydroxide of about 25% by weight.

8. Process according to claim 1, wherein step (c-1) and/or (c-2) is carried out at a temperature between 8° and 95° C. and/or for at least 70 minutes.

9. Process according to claim 1, wherein step (c-1) is carried out at a pH of about 2.

10. Process according to claim 1, wherein step (c-2) is carried out at a pH of about 3.6.

11.-12. (canceled)

13. Process according to claim 1, wherein solid B is fed as a suspension at a concentration of between 200 and 500 g per liter.

14. Process according to claim 1, further comprising the steps of:
(e) contacting the liquid fraction D with a barium(II) source, a sulfate source and a sulfide source so as to precipitate substantially all the Ra(II) and Pb(II) species comprised in said liquid fraction in the form of RaSO₄ and PbS; thus obtaining:
a solid fraction E comprising lead sulfide and sulfate salts of barium and radium, and
a liquid fraction F comprising mixed rare earth metal chloride salts;
(f) separating the liquid fraction F from the solid fraction E.

15. Process according to claim 14 wherein step (e) comprises the steps of:
(e-1) precipitating sulfate salts of radium by contacting the liquid fraction D with a barium(II) source and a sulfate source;
(e-2) precipitating lead sulfide by contacting the product obtained in step (e-1) with a sulfide(II) source.

16. Process according to claim 15 wherein step (e-1) satisfies one or more of:
(i) the sulfate source is potassium sulfate;
(ii) an amount of sulfate source is such that the concentration of sulfate in the medium of step (f) is of between 5 and 15 g per liter;
(iii) the barium(II) source is barium(II) chloride;
(iv) an amount of barium(II) source is such that the molar ratio of Ba(II) to sulfate is of between 1:5 and 1:15;
(v) a temperature of between 50° C. and 90° C.; and/or
(vi) a reaction time of step (e-1) is of at least 45 minutes.

17.-21. (canceled)

22. Process according to claim 15, wherein step (e-2) satisfies one or more of:
(i) the pH of the reaction medium of step (e-2) is 3.6 and is optionally adjusted by addition of an alkaline hydroxide;
(ii) the sulfide(II) source is sodium sulfide;
(iii) the amount of sulfide(II) source is such that the molar ratio of lead to sulfide is about 1:1; and/or
(iv) a temperature of between 50° C. and 90° C.

23.-25. (canceled)

26. Process according to claim 14, further comprising the steps of:
(g) converting substantially all the Ce(III) cations of the liquid fraction F in Ce(IV) hydroxide by submitting said liquid fraction F to oxidative conditions; thus obtaining:
a solid fraction G consisting essentially of cerium(IV) hydroxide; and
a liquid fraction H comprising rare earth metal chloride salts; and
(h) separating the liquid fraction H from the solid fraction G.

27. Process according to claim 26 wherein step (g) comprises contacting liquid fraction F with sodium hypochlorite.

28. Process according to claim 26, wherein step (g) satisfies one or more of:
(i) a temperature of between 50° C. and 90° C.;
(ii) a pH of the reaction medium of step (g) is of between 3 and 4; and/or
(iii) liquid fraction F is contacted with sodium hypochlorite that is present in an amount of at least 2 moles per each mole of cerium(III) chloride in liquid fraction F.

29.-30. (canceled)

31. Process according to claim 26, further comprising the steps of:
(i) contacting the liquid fraction H with an alkaline carbonate salt so as to precipitate substantially all the rare earth metals comprised in said fraction in the form of carbonate salts; thus obtaining
a solid fraction I consisting of mixed rare earth metal carbonate salts, and
a liquid fraction J comprising rare earth metal chloride salts and
j) separating the solid fraction I from the liquid fraction J.

32. Process according to claim 31, wherein step (i) satisfies one or more of:
(i) temperature of between 50° C. and 100° C.;
(ii) the alkaline carbonate salt is sodium carbonate and is added as an aqueous solution having a concentration of between 150 and 200 grams per liter; and/or
(iii) an amount of alkaline carbonate salt is such that the pH of the solution of step (i) is 6.

33.-34. (canceled)

35. Process according to claim 1, further comprising the step of:
(k) precipitating trisodium phosphate from liquid fraction A and
(l) isolating said trisodium phosphate by solid-liquid separation, thus obtaining trisodium phosphate and a liquid fraction K.

36. Process according to claim 35 wherein trisodium phosphate is precipitated by water evaporation.

37.-40. (canceled)

41. Process according to claim 35, further comprising the steps of:
(m) contacting the liquid fraction K with calcium oxide in a sufficient amount to precipitate substantially all the silicate salts comprised in said liquid fraction in the form of calcium silicate; thus obtaining:
a solid fraction L comprising calcium silicate, and
a liquid fraction M enriched in sodium hydroxide, and
(n) isolating said liquid fraction M by solid-liquid separation.

42. Process according to claim 41 further comprising the step of feeding liquid fraction M to step (a).

43.-51. (canceled)
